(19) United States
(12) Patent Application Publication
(10) Pub. No.: US 2014/0188300 A1
(43) Pub. Date: Jul. 3, 2014

(54) METHOD OF CONTROLLING DISTRIBUTED POWER SUPPLIES

(71) Applicant: LSIS CO., LTD., Anyang-si (KR)

(72) Inventor: Khanh-Loc NGUYEN, Anyang-si (KR)

(73) Assignee: LSIS CO., LTD., Anyang-si (KR)

(21) Appl. No.: 14/139,322

(22) Filed: Dec. 23, 2013

(30) Foreign Application Priority Data
Dec. 28, 2012 (KR) 10-2012-0156573

(51) Int. Cl. G06F 1/26

(52) U.S. Cl. CPC G06F 1/26
USPC 700/297

(57) ABSTRACT

A method of controlling distributed power supplies is provided. In the method of controlling one or more distributed power supplies included in a microgrid, as a feeder flow control mode, an operation mode of a first distributed power supply is set, which is firstly connected to a common coupling point of the microgrid and a main grid. A second distributed power supply is selected, which is different from the first distributed power supply. A next operation mode of the second distributed power supply is determined on a basis of a current operation mode of the selected second distributed power supply and output power of the first distributed power supply. The next operation mode of the second distributed power supply is set as one of the feeder flow control mode or a unit power control mode according to the determined result.

### CROSS-REFERENCE TO RELATED APPLICATIONS

Pursuant to 35 U.S.C. §119(a), this application claims the benefit of earlier filing date and right of priority to Korean Application No. 10-2012-0156573, filed on Dec. 28, 2012, the contents of which is incorporated by reference herein in its entirety.

### BACKGROUND

The present disclosure relates to a method of controlling distributed power supplies, and more particularly, to a method of controlling distributed power supplies connected to a main grid of a power system.

While recently an amount of power consumption in Korea tends to continuously increase, it is difficult to expand power generation equipment with construction limitation of large thermal and nuclear power plants due to construction site securing problems, environmental problems, and resource supply and demand problems, etc. In addition, as industries are advanced, a demand for power quality also increases. Accordingly, it is increasingly demanded to develop various types of energy resources in consideration of demand management and control.

Due to this, a distributed power supply type power link system is developed by using renewable energy such as wind-power, solar power, and fuel cell etc. A microgrid, as a network system formed of distributed power supplies connected to a main grid of a power system, can operate independently or in connection with the main grid according to a system situation, and also enables improvement of energy efficiency, inverse transmission of power, and reliability improvement through efficient use of the distributed power supplies, so it emerges as a next power IT technology.

FIG. 1 is a block diagram illustrating a related art microgrid system.

Referring to FIG. 1, a microgrid system may include a main grid 10 of a power system and a microgrid 30 connected to the main grid 10 at a common coupling point 20. The microgrid 30 may include a load 32 connected to the main grid 10 through a feeder 31 and a distributed power supply 33. The load 32 and distributed power supply 33 may respectively include a plurality of loads and a plurality of distributed power supplies. The load 32 may receive power from at least one of the main grid 10 and the distributed power supply 33 according to a situation.

Power supplied to the load 32 may be kept constant, because powers supplied from the distributed power supply 33 and the main grid 10 are properly distributed. Also, since a main power supplier supplying power to the main grid 10 can control power supply with reference to the microgrid 30, the main power supplier efficiently operates a microgrid system.

However, when powers of the distributed power supply and the main grid 10 are linked and power consumed by the load 32 in the microgrid 30 is changed, the main power supplier of the main grid 10 may not control the microgrid 30 in a view of the main grid 10. Accordingly, output power of the distributed power supply 33 is not maximally used. In order to keep a feeder flow at a common coupling point 20 constant by using output power of the distributed power supply 33, the microgrid 30 may be considered as a load. However, in this method, when the load 32 consumes maximum power, an output of the distributed power supply 33 is limited and not fluid in order to keep the feeder flow.

Furthermore, when the microgrid 30 is disconnected from the main grid 10 and changed to an independent system, separately operating distributed power supply 33 is required to change its operating frequency to a local frequency in order to keep the existing feeder flow. In this case, when a frequency changing width is great, unnecessary power consumption is resulted and the entire system becomes unstable.

To address this, a mode of the distributed power supply is set, and the mode can be changed according to a reference value. However, since a magnitude of the feeder flow is not an absolute value, the system operates fluidly, and malfunction or instability may result. Due to this, a hysteresis scheme may be used, but its operation range is required to be set widely. Therefore, similar limitations may result.

### SUMMARY

Embodiments provide methods of controlling distributed power supply capable of allowing a microgrid system to stably operate.

Embodiments also provide a method of controlling distributed power supply capable of efficiently controlling an output of the distributed power supply according to a load state and an operation mode as well as reducing malfunction or instability due to frequent mode changes.

In one embodiment, a method of controlling one or more distributed power supplies included in a microgrid, the method including: setting, as a feeder flow control mode, an operation mode of a first distributed power supply firstly connected to a common coupling point of the microgrid and a main grid; selecting a second distributed power supply which is different from the first distributed power supply; determining a next operation mode of the second distributed power supply on a basis of a current operation mode of the selected second distributed power supply and output power of the first distributed power supply; and setting the next operation mode of the second distributed power supply as one of the feeder flow control mode or a unit power control mode according to the determined result.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating a typical microgrid system.

FIG. 2 is a block diagram illustrating a power system including a distributed power supply control apparatus for performing a distributed power supply control method according to embodiments.

FIG. 3 is a block diagram of a distributed power supply control apparatus 100 for performing a distributed power supply control method according to embodiments.

FIG. 4 partially illustrates a microgrid system operated by a distributed power supply control apparatus 100 according to embodiments.

FIGS. 5 and 6 illustrate in detail the distributed power supply operating in a feeder flow control (FFC) mode.

FIGS. 7 and 8 illustrate in detail the distributed power supply operating in a unit power control (UPC) mode.

FIG. 9 is a flow chart illustrating a distributed power supply control method according to embodiments.

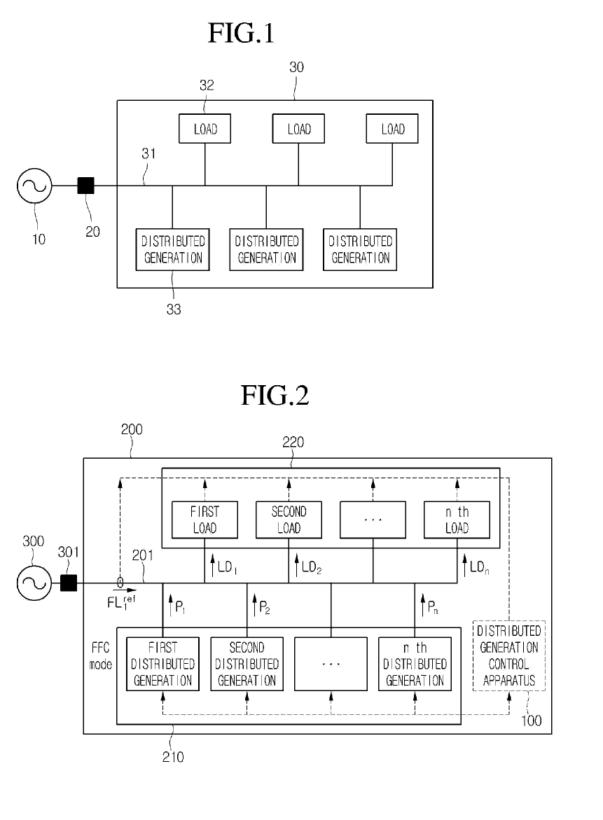

### DETAILED DESCRIPTION OF THE EMBODIMENTS

Reference will now be made in detail to the embodiments of the present disclosure, examples of which are illustrated in the accompanying drawings.

Following description only exemplifies the principle of the present disclosure. Although the description of the principle may not be clear or all possible embodiments of the present disclosure is not illustrated in the specification, those skilled in the art can embody the principle of the present disclosure and invent various apparatus within the scope and concept of the present disclosure from the description. Also, all the conditional terms and embodiments described in the specification are intended to make the concept of this disclosure understood, in principle, and the present disclosure should be understood not limited to the described embodiments or conditions only.

Also, all the detailed description on a particular embodiment as well as the principle, view points and embodiments should be understood to include structural and functional equivalents. Those equivalents should he understood to include those currently known and to be developed in future. That is, they include all devices developed to perform the function of the element disclosed in the present disclosure, regardless of their structures.

For example, block diagrams of the specification should be understood to show a conceptual Viewpoint of an exemplary circuit that embodies the principle of the present disclosure. Similarly, all the flow charts, diagrams and pseudo-code may can he implemented as software can be stored in a computer-readable medium, practically. Even though a computer or a process is not described evidently, they should be understood to show diverse processes performed by a computer or a processor.

The functions of elements illustrated in the drawing including a functional block marked as a processor or a similar concept of the processor can be provided not only by a dedicated hardware but also by using hardware capable of executing proper software that can perform the functions. When the functions of elements are provided by a processor, the processor can be a single processor dedicated to the function only, a single shared processor or a plurality of individual processors, part of which can be shared.

The apparent use of terms such as processor, controller, or terms having similar concept should not be exclusively construed to be hardware capable of executing software, but include digital signal processor (DSP) hardware, ROM, RAM and non-volatile memory for recording software implicitly. Here, other known or commonly used hardware can be included.

In claims of the specification, an element expressed as a means for performing a function described in the detailed description part of this specification is intended to include a combination of circuits that performs the function, or all methods for performing the function including all formats of software including firmware and micro code. They are connected to a proper circuit for executing the software. The present disclosure defined by such claims is connected to other functions provided by various means in a method defined by the claims. Thus, any means that can provide the function should be understood to be equivalent to what is figured out from the specification.

Other objects and aspects of the disclosure will become apparent from the following description of the embodiments with reference to the accompanying drawings, which is set forth hereinafter. The same reference number is given to the same element, though it appears in different drawings. (Like reference numerals designate like elements throughout the specification.) Also, any description that may unnecessarily blur the point of the present disclosure is omitted from the detailed description. Hereinafter, preferred embodiments of the present disclosure will be described With reference to the accompanying drawings.

FIG. 2 is a block diagram illustrating a power system including a distributed power supply control apparatus according to the embodiments.

Referring FIG. 2, the power system including a distributed power supply control apparatus 100 for controlling the distributed power supplies according to the embodiments includes a main grid 300 and a microgrid 200. The microgrid 200 includes a plurality of distributed power supplies 210, a plurality of loads 220, and the distributed power supply control apparatus 100 for controlling each operation of the plurality of distributed power supplies 210 and the plurality of loads 220.

The main grid 300 plays a role of a main power supplying unit, and provides, to the microgrid 200, power received from a main power provider through a power system. At this time, the main grid 300 and the microgrid 200 may be connected to each other at a common coupling point 301.

A power flow flowing through a feeder towards the microgrid 200 from the common coupling point 301 is called a feeder flow FL. When an operation mode of a first distributed power supply is a feeder flow control (FFC) mode as shown in FIG. 2, the feeder flow FL may be controlled according to a reference value FL1ref. A detailed operation mode of the distributed power supply may be described later.

The microgrid 200 may provide load consumption powers LD1 to LDn necessary for the plurality of loads 220 according to powers P1 to Pn internally provided from each of the plurality of distributed power supplies 210 and power externally transmitted from the main grid 300.

The distributed power supply control apparatus 100 may be connected to the plurality of distributed power supplies 210 and the plurality of loads 220. The distributed power supply control apparatus 100 may measure load consumption power of each of the plurality of loads 220 and measure an output of each of the plurality of distributed power supplies 210. Also, the distributed power supply control apparatus 100 may change an operation mode of a second distributed power supply on the basis of outputs of the first distributed power supply and other distributed power supplies. For example, as shown in FIG. 2, the distributed power supply control apparatus 100 may change the operation mode of the first distributed power supply to an FFC mode and adjust power input from the main grid 300 into the reference value FL1ref.

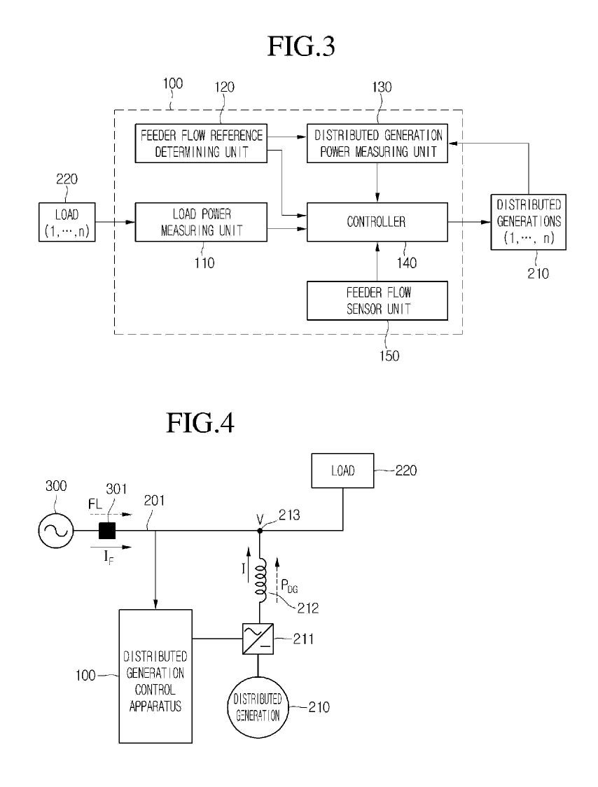

FIG. 3 is a detailed block diagram of the distributed power supply control apparatus 100 according to embodiments.

Referring to FIG. 3, the distributed power supply control apparatus 100 according to embodiments includes a load power measuring unit 110, a power measuring unit 130, a feeder flow reference value determining unit 120, a feeder flow sensor unit 150, and a controller 140.

The load power measuring unit 110 may be connected to each of the plurality of loads 220 and measure load consumption power consumed by each of the connected loads 220. The load power measuring unit 110 may also calculate maximum consumption power of the plurality of loads 220. For example, the load power measuring unit 110 may calculate current maximum consumption power by summing total consumption powers of the plurality of the connected loads 220.

Referring to FIG. 2 again, the load power measuring unit 110 may measure consumption powers LD1 to LDn of the plurality of loads 220, and calculate maximum consumption power by summing the measured values of LD1 to LDn.

In particular, the load power measuring unit 110 may measure a next total consumption power variation of loads of microgrid according to the below equation 1.

$$( \begin{matrix}Next total consumption power \\ variation of loads of microgrid\end{matrix} ) = {\sum }_{k = 1}^{n} {W}_{k} \times ( a current {LD}_{k} - a previous {LD}_{k} ) \qquad ( Equation 1 )$$

In Equation 1, Wk is a weighting factor of a k-th load. Wk may mean importance of the k-th load.

Referring to FIG. 3 again, the distributed power supply power measuring unit 130 may be connected to each of the plurality of distributed power supplies 210, and measure output power of each of the connected distributed power supplies 210. For example, the distributed power supply power measuring unit 130 may measure current values and voltage values output from each of the plurality of distributed power supplies 210 and calculate output powers thereof.

Furthermore, the plurality of distributed power supplies 210 may have different outputs according to a kind and operation mode thereof. Accordingly, the distributed power supply power measuring unit 130 may perform predetermined communications with other measuring devices or the plurality of distributed power supplies 210, discriminate the kind and operation mode of each of the plurality of distributed power supplies, and measure each output thereof.

The distributed power measuring unit 130 may also measure total output powers of the plurality of distributed power supplies 210 and calculate entire output power thereof.

In order to measure power for each operation mode, the distributed power supply power measuring unit 130 may also separately measure first output powers of the distributed power supplies operating in a first mode and second output powers of the distributed power supplies operating in a second mode, and transfer the first and second output powers to the controller 140.

The feeder flow reference value determining unit 120 may determine a reference value of an feeder flow towards the microgrid 200 from the main grid 300 on the basis of distributed power supply output powers measured by the distributed power supply measuring unit 180 and load consumption powers measured by the load power measuring unit 110.

The feeder flow sensor unit 150 may measure power of the feeder flow.

The controller 140 may change at least one operation mode from among the plurality of distributed power supplies 210 on the basis of a power value of the measured feeder flow, output values of the measured distributed power supplies and the determined feeder flow reference value. In detail, the controller 140 may change an operation mode to any one of a first mode allowing flows of feeders connecting the main grid 300 and the plurality of distributed power supplies 210 to be kept constant and a second mode allowing output powers of the distributed power supplies 210 to be kept constant, and control powers of flows of the feeders connected to the main grid 300 to be kept constant.

Hereinafter, an operation and effect of the controller 140 may be described in detail with reference to FIGS. 4 to 8. In relation to FIGS. 4 to 8, the distributed power supply control apparatus 100 is described in detail which controls operations of one distributed power supply 210 and one load 220.

FIG. 4 partially illustrates a microgrid system operated by the distributed power supply control apparatus 100 according to the embodiments.

Referring to FIG. 4, the distributed power supply control apparatus 100 may control the distributed power supply 210 in a first mode or a second mode.

Here, the first mode may be an FFC mode allowing a feeder flow towards the distributed power supply 210 to be kept constant at a common coupling point 301 at which the main grid 300 and the microgrid 200 including the distributed power supply control apparatus 100, the distributed power supply 210 and the load 220 are connected.

In the FFC mode, the distributed power supplies 210 may adjust output power P_{DG} thereof according to an internal consumption power change of the load 220. Accordingly, the feeder flow from the main grid 300 connected to the distributed power supply 210 may be kept constant. Since the main power provider providing power to the main grid 300 may set and control the microgrid 200 including the distributed power supply 210 as a load consuming constant power, it is easy to measure and control power provided to the microgrid 200.

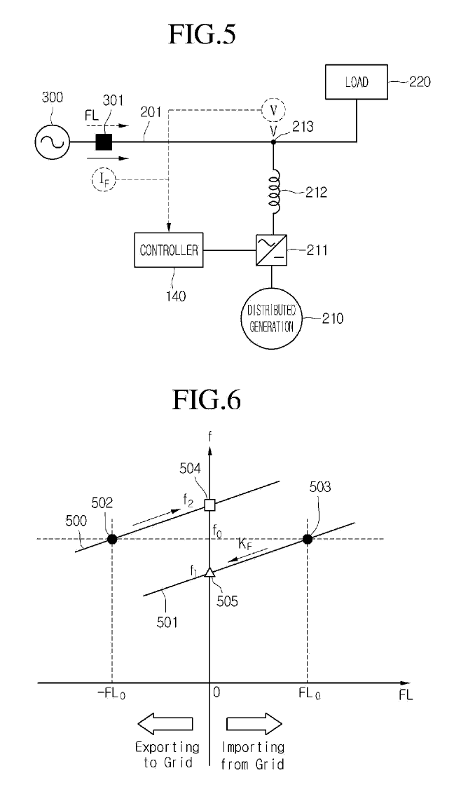

FIGS. 5 and 6 illustrate in detail that the distributed power supply 210 operate in the FFC mode.

Referring to FIG. 5, the distributed power supply 210 may be connected to an inverter 211, the inverter 211 may be connected to the controller 140 and an inductor 212, and the inductor 212 may be connected to the common coupling point 301 and the load 220.

Here, the controller 140 may operate the distributed power supply 210 in the FFC mode. At this time, the controller 140 may measure a local voltage V of the inductor 212 and a feeder current I_{F} flowing towards the microgrid 200, calculate a feeder flow FL on the basis of the measured local voltage V and feeder current I_{F}, and control output power P_{DG} of the distributed power supply 210 through the inverter 211 in order to keep the feeder flow FL constant.

Accordingly, as described above, a feeder flow FL in a preceding stage of the distributed power supply 210 may be kept constant and it becomes easy for the main power provider to measure load power and control consumption power.

FIG. 6 represents a droop characteristic curve in a case where the distributed power supply operates in an FFC mode.

Referring to FIG. 6, a change of the feeder flow FL of FIG. 5 can be known according to a power frequency f in the FFC mode.

First and second lines 500 and 501 are curves, namely power import and export curves, representing operation points according to a frequency change, and may have a predetermined slope K_{F} according to droop characteristics in the FFC mode.

When operating in the FFC mode, the distributed power supply 210 may keep a feeder flow as FL₀ (when power is imported) or −FL₀ (when power is exported) for a reference frequency f₀ in a state of not being separated from the main grid 300. The operation points at this time may be a point 502 and a point 503.

However, when the distributed power supply 210 is separated from the main grid 300, an operation mode of the distributed power supply 210 is required to be changed to an independent operation mode. At this time, since the distributed power supply 210 is disconnected from the main grid 300, a value of a feeder flow is required to become 0, a power frequency is required to be changed to keep power input to or power output from the load 220, and accordingly the operation point is also required to be changed.

For example, in a case where the feeder flow is FL0 (when the power is imported) when the distributed power supply 210 is separated from the main grid 300, the power frequency may be changed to be decreased from f₀ to f₁. Accordingly, the operation point 503 of the distributed power supply 210 may be changed to an operation point 505.

In addition, for example, in a case where the feeder flow is −FL0 (when the power is exported) when the distributed power supply 210 is separated from the main grid 300, the power frequency may be changed to be increased from f₀ to f₂. Accordingly, the operation point 502 of the distributed power supply 210 may be changed to an operation point 504.

Like this, when a power frequency is changed in the FFC mode, an increase or decrease in the power frequency and an operation point change may be performed according to the droop characteristics curve as shown in FIG. 6. At this time, power loss and system instability due to the frequency change may be resulted.

In order to solve this, the distributed power supply control apparatus 100 may reduce a frequency change by constantly keeping power flow as a predetermined value.

Furthermore, the distributed power supply control apparatus 100 may control the distributed power supply 210 in a second mode by an operation of the controller 140. The second mode may be a UPC mode for keeping output power of the distributed power supply 210 constant. In case of the UPC mode, the distributed power supply apparatus 100 may constantly keep an output of the distributed power supply 210 as a predetermined value regardless of an amount of a feeder flow.

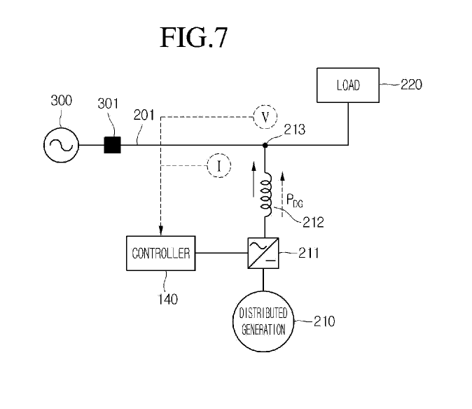

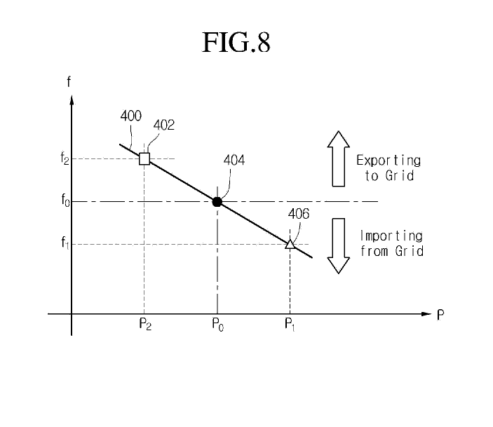

FIGS. 7 and 8 illustrate in detail that the distributed power supply 210 operates in a UPC mode.

As shown in FIG. 7, the controller 140 of the distributed power supply control apparatus 100 may operate the distributed power supply 210 in the UPC mode.

For example, the distributed power supply control apparatus 100 may control the inverter 211 connected to the distributed power supply 210 and control power P_{DG} to be kept constant, where the power P_{DG} is a multiplication of the current I flowing through the inductor 212 connected to an output end of the inverter 211 and a voltage V.

In case of the UPC mode, the distributed power supply control apparatus 100 may control to allow an output from the distributed power supply 210 to be constant regardless of a load change of the microgrid 200.

FIG. 8 represents droop characteristic curves of a frequency to output power.

As shown in FIG. 8, when the distributed power supply 210 operating in the UPC mode is connected to the main grid 300, the output power P of the distributed power supply 210 may be kept constant as P₀ for a reference frequency f₀.

However, when the distributed power supply 210 is separated from the main grid 300, the operation mode of the distributed power supply 210 is required to be changed to an independent operation mode. At this time, the distributed power supply 210 is disconnected from the main grid 300, a power frequency is changed in order to keep power input to or power output from the load 220, and accordingly the output power P is changed to power P₁ (when the power is imported) or P₂ (when the power is exported).

In addition, an output power frequency of the distributed power supply 210 may be changed to f₁ or f₂ and accordingly power loss and system instability may be resulted. Therefore, in independent operation performed by being separated from the main grid 300, the distributed power supply control apparatus 100 may reduce a frequency change caused by the distributed power supply 210 operating in the UPC mode by operating the distributed power supply 210, which is firstly connected to the main grid feeder 201, in the FFC mode.

As described above, in the FCC mode, it is easy for the main power provider to measure and control consumption power for the main grid 300. However, in the FFC mode, the output of the distributed power supply 210 is severely varied according to load variation, and thus hardly controlled.

On the contrary, in the UPC mode, since being limited to a predetermined value, the output of the distributed power supply 210 may not be used maximally. Therefore, the main power provider to the main grid 300 may not possibly perform power supply prediction and control according to the load variation.

Accordingly, according to the embodiments, the controller 140 may control, in the FFC mode, the distributed power supply 210 firstly connected to the main grid connection feeder 201, allow a power flow provided from the main grid 300 to be kept constant, change an operation mode of at least one of a plurality of distributed power supplies 210 to the UPC mode or the FFC mode, and control power transfer from the distributed power supply 210 to the load 220 to have maximum efficiency.

The controller 140 may control, in the FFC mode, a first distributed power supply firstly connected to the main grid connection line 201, for example, directly connected to the common coupling point 301. Accordingly, it is able to allow load variation not to occur in a view of the main grid 300. The controller 140 may control other second to n-th distributed power supplies in the UPC mode or the FFC mode, and flexibly adjust output power of the microgrid 200 to cope with the load variation.

Furthermore, in an embodiment, the controller 140 may change a mode of at least one distributed power supply operating in the FFC mode to the UPC mode or change a mode of at least one distributed power supply operating in the UPC mode to the FFC mode.

When frequent mode changes are performed by the controller 140 according to a magnitude of a feeder flow and load variation, system instability and malfunction may be resulted.

Hereinafter, an effective method of controlling distributed power supplies is described. The method may keep the above-described effects according to the operation of the distributed power supply control apparatus 100, while reducing frequent mode changes, according to embodiments.

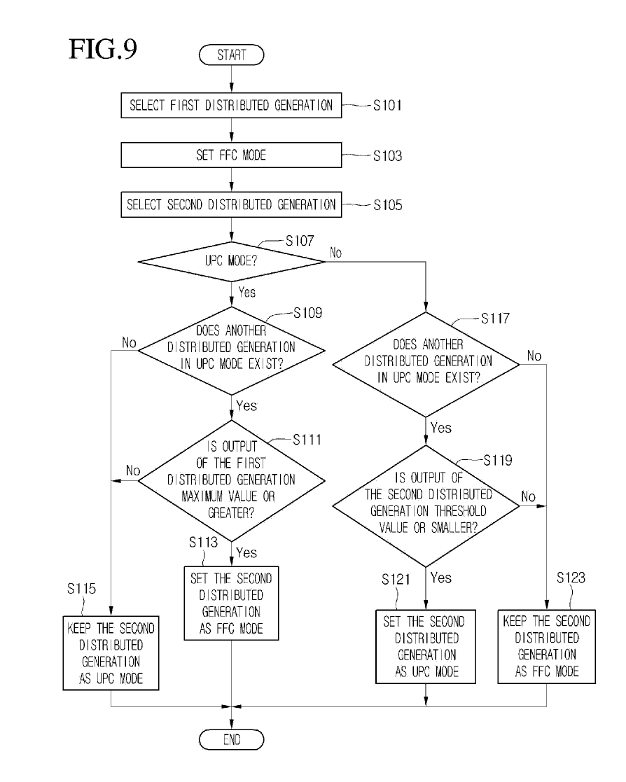

FIG. 9 is a flow chart illustrating a method of controlling distributed power supplies according to embodiments.

Referring to FIG. 9, the controller 140 selects a first distributed power supply (operation S101). Here, the first distributed power supply may be firstly connected to the common coupling point 301 between the microgrid 200 and the main grid 300.

The controller 140 may set the first distributed power supply as an FFC mode (operation S103). As the first distributed power supply is set as the FFC mode, a main power provider providing power to the microgrid 200 through the main grid 300 may manage the microgrid 200 as a load.

Then, the controller 140 selects a second distributed power supply (operation S105).

Here, the second distributed power supply may be different distributed power supply from the first distributed power supply in the microgrid 200. For example, the second distributed power supply may be connected in a lower priority than that of the first distributed power supply at the common coupling point 301.

The second distributed power supply may be a target of operation mode determination. In detail, according to an embodiment described below, an operation mode may be controlled not to be frequently changed by specifically determining an operation mode of the second distributed power supply in each determining process when the operation mode is changed for maximum efficiency of power transfer.

Then, the controller 140 determines whether the operation mode of the second distributed power supply is a UPC mode (operation S107).

According to an embodiment, the second distributed power supply may operate in any one of a UPC mode or a FFC mode. Accordingly, the controller 140 may determine whether the second distributed power supply operates in the UPC mode or the FFC mode by determining whether the operation mode of the second distributed power supply is the UPC mode.

When the operation mode of the second distributed power supply is determined as the UPC mode, the controller 140 determines whether there are other distributed power supplies operated in the UPC mode (operation S109).

The controller 140 may determine whether there are other distributed power supplies by checking that there are other distributed power supplies connected between the second distributed power supply and the common coupling point 301. The controller 140 may also determine whether an operation mode of the existing other distributed power supply is the UPC mode. Accordingly, the controller 140 may determine the existence of the other distributed power supply operating in the UPC mode by using the above-described two operations.

When the other distributed power supply exists between the second distributed power supply and the common coupling point 301, the controller 140 determines whether an output from the first distributed power supply is a maximum value or greater (operation S111). In particular, the controller 140 may determine whether a sum of an output from the first distributed power supply and the next total consumption power variation of loads of microgrid is a maximum value or greater.

The maximum value may be preset in correspondence to the first distributed power supply, and mean maximum power that the first distributed power supply is allowed to output. Accordingly, a case that the output of the first distributed power supply exceeds the maximum value may indicate that an output from another distributed power supply besides the first distributed power supply is needed.

Furthermore, in case where the other distributed power supply in the unit power control mode does not exist between the common coupling point 301 between the first distributed power supply and the main grid 300 and the common coupling point 301 between the second distributed power supply and the main grid 300, or in a case where such other distributed power supply exists but an output of the first distributed power supply is not the maximum value or greater, the controller 140 keeps the operation mode of the second distributed power supply as the UPC mode (operation S115).

However, when the output of the first distributed power supply is greater than the maximum value, the controller 140 sets the second distributed power supply as the FFC mode (operation S113), and controls the feeder flow in a preceding stage of the first distributed power supply, which is connected to the common coupling point 301, to be kept constant through a mode change of the second distributed power supply.

In other words, in case where the output of the first distributed power supply is the maximum value or greater, when another distributed power supply operating in the UPC mode exists between the first and second distributed power supplies, the controller 140 sets the operation mode of the second distributed power supply as the FFC mode. When the other distributed power supply does not exist or the output of the first distributed power supply is smaller than the maximum value, the controller 140 keeps the operation mode of the second distributed power supply as the UPC mode.

Accordingly, the controller 140 of the distributed power supply control apparatus 100 may prevent unnecessary mode changes from occurring and keep the feeder flow in the preceding stage of the first distributed power supply maximally constant.

Furthermore, in a case where the second distributed power supply does not operate in the UPC mode, the controller 140 determines whether another distributed power supply operating in the UPC mode exists (operation S117).

The controller 140 may determines whether the other distributed power supply exists by checking whether the other distributed power supply, which is connected between the second distributed power supply and the common coupling point 301, exists, like operation S109.

The controller 140 may determine whether an operation mode of the other distributed power supply is the UPC mode. Accordingly, the controller 140 may determine whether the other distributed power supply operating in the UPC mode exists between the second distributed power supply and the common coupling point 301 by using the above-described two operations.

When the other distributed power supply exists between the second distributed power supply and the common coupling point 301, the controller 140 determines that the output of the second distributed power supply is a threshold value or smaller (operation S119). In particular, the controller 140 may determine whether sum of the output of the second distributed power supply and the next total consumption power variation of loads of microgrid is a threshold value or smaller.

The output threshold value of the second distributed power supply may be preset in correspondence to the second distributed power supply. Accordingly, a case where the output of the second distributed power supply operating in the FFC mode is smaller than the threshold value indicates that the output is required to be increased.

Accordingly, in a case where the other distributed power supply in the UPC mode does not exist between a common coupling point between the first distributed power supply and the main grid 300 and a common coupling point between the second distributed power supply and the main grid 300, or in a case where such other distributed power supply exists but an output of the first distributed power supply exceeds the threshold value, the controller 140 keeps the operation mode of the second distributed power supply as the FFC mode (operation S123). Accordingly, the microgrid system is assured to be stably kept without frequent mode changes.

However, when the output of the first distributed power supply is the threshold value or smaller, the controller 140 may set the second distributed power supply as the UPC mode (operation 5121) and increase the output of the second distributed power supply.

In other words, in a case where the output of the first distributed power supply is the threshold value or smaller, when another distributed power supply operating in the UPC mode exists between the first and second distributed power supplies, the controller 140 sets the operation mode of the second distributed power supply as the UPC mode. When the other distributed power supply does not exist or the output of the first distributed power supply is greater than the threshold value, the controller 140 keeps the operation mode of the second distributed power supply as the FFC mode.

Accordingly, the controller 140 of the distributed power supply control apparatus 100 may keep the feeder flow in the preceding stage of the first distributed power supply maximally constant, and keep the output of the second distributed power supply operating in the feeder flow control mode in a proper level. In addition, since the controller 140 may keep the second distributed power supply in the FFC mode according to predetermined conditions or change to the UPC mode, frequent mode change operations for keeping the feeder flow can be reduced. Accordingly, stability of the microgrid system can be improved and malfunctions thereof can be prevented.

Furthermore, the method of controlling distributed power supplies as described in relation to FIG. 9 can be performed in the distributed power supply control apparatus 100. Operations of the distributed power supplies can be stably controlled and output efficiency is kept by preferentially changing an operation mode on the basis of output power from the first and second distributed power supplies.

According to embodiments, for a microgrid system using inverter-based distributed power supplies, by controlling modes of the distributed power supplies, the microgrid 100 can be operated as a load which can be controlled by the main grid 300 and also controlled to have maximum power efficiency according to load variation. In addition, as described above, by reducing frequency mode changes of the distributed power supplies, system instability and malfunctions can be prevented.

According to embodiments, an apparatus for controlling distributed power supplies can reduce frequent changes of an operation mode by setting an operation mode of a first distributed power supply, which is firstly connected to a common coupling point of a main grid, as a feeder flow control mode, determining and controlling operation modes of other distributed power supplies on the basis of output power of the first distributed power supply. Accordingly, an output of the distributed power supply can be efficiently controlled according to changes of a load state and an operation mode, and malfunction according to the frequent changes can be reduced.

Also, a frequency change width according to an operation mode change can be reduced and a microgrid system can be stably kept.

Since operation modes of a plurality of distributed power supplies can be changed fluidly for an efficient output and a frequency of the changes can be also reduced, the outputs of the distributed power supplies can be efficiently controlled.

The method of controlling distributed power supplies according to embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage.

The computer readable recording medium can also be distributed over network coupled computer systems so that the computer readable code is stored and executed in a distributed fashion. Also, functional programs, codes, and code segments for accomplishing the present disclosure can be easily construed by programmers skilled in the art to which the present disclosure pertains.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling one or more distributed power supplies included in a microgrid, the method comprising:
setting, as a feeder flow control mode, an operation mode of a first distributed power supply firstly connected to a common coupling point of the microgrid and a main grid;
selecting a second distributed power supply which is different from the first distributed power supply;
determining a next operation mode of the second distributed power supply on a basis of a current operation mode of the selected second distributed power supply and output power of the first distributed power supply; and
setting the next operation mode of the second distributed power supply as one of the feeder flow control mode or a unit power control mode according to the determined result.

2. The method according to claim 1, wherein the determining of the next operation mode comprises:
when the current operation mode of the second distributed power supply is the unit power control mode, determining an operation mode of another distributed power supply connected between the second distributed power supply and the common coupling point;
when the operation mode of the other distributed power supply is the unit power control mode, determining whether output power of the first distributed power supply is a preset maximum value or greater; and
when the output power of the first distributed power supply is the maximum or greater, determining the next operation mode of the second distributed power supply as the feeder flow control mode.

3. The method according to claim 2, further comprising, when the output power of the first distributed power supply is smaller than the maximum value, keeping the next operation mode of the second distributed power supply as the unit power control mode.

4. The method according to claim 2, further comprising, when the other distributed power supply operating in the unit power control mode does not exist between the second distributed power supply and the common coupling point, keeping the next operation mode of the second distributed power supply as the unit power control mode.

5. The method according to claim 1, wherein the determining of the next operation mode comprises:
when the current operation mode of the second distributed power supply is the feeder flow control mode, determining an operation mode of another distributed power supply connected between the second distributed power supply and the common coupling point;
when the current operation mode of the second distributed power supply is the unit power control mode, determining whether the output power of the second distributed power supply is a preset threshold value or smaller; and
when the output power of the second distributed power supply is the threshold value or smaller, determining the next operation mode of the second distributed power supply as the unit power control mode.

6. The method according to claim 5, further comprising, when the output power of the second distributed power supply is greater than the threshold value, keeping the next operation mode of the second distributed power supply as the feeder flow control mode.

7. The method according to claim 5, further comprising, when the other distributed power supply operating in the unit power control mode does not exist between the second distributed power supply and the common coupling point, changing the next operation mode of the second distributed power supply to the unit power control mode.

8. The method according to claim 1, wherein the feeder flow control mode is a distributed power supply control mode keeping, constant, power flow of a feeder to which the distributed power supplies and the main grid are connected.

9. The method according to claim 1, wherein the unit power control mode is a distributed power supply control mode keeping, constant, output powers of the distributed power supplies.

10. The method according to claim 1, further comprising changing, to a feeder flow control mode, next operation modes of other distributed power supplies sequentially operating in the unit power control mode until output power of the first distributed power supply is smaller than a preset maximum value.

11. The method according to claim 1, further comprising changing, to a unit power control mode, next operation modes of other distributed power supplies sequentially operating in the feeder flow control mode until output power of the second distributed power supply is a preset threshold value or greater.

12. The method according to claim 10, wherein the maximum value is determined by a coefficient of a droop characteristic curve when the first distributed power supply operates in the unit power control mode.

13. The method according to claim 1, further comprising:
predicting a next total consumption power variation of loads of the microgrid, and
wherein determining the next operation mode of the second distributed power supply comprises:
determining the next operation mode of the second distributed power supply on a basis of the current operation mode of the selected second distributed power supply, the output power of the first distributed power supply, and the predicted next total consumption power variation of loads of the microgrid.

14. The method according to claim 13, wherein predicting the next total consumption power variation of loads of the microgrid comprises:
predicting the next total consumption power variation of loads of the microgrid based on consumption power differences respectively corresponding to the loads, wherein each of the consumption power differences is a difference between a current consumption power and a previous consumption power of a corresponding load.

15. The method according to claim 14, wherein predicting the next total consumption power variation of loads of the microgrid based on consumption power differences comprises:
predicting the next total consumption power variation of loads of the microgrid based on a weighted sum of consumption power differences.

16. The method according to claim 15, wherein the next total consumption power variation of loads of microgrid is calculated according to the following equation:
$$( Next total consumption power variation of loads of microgrid ) = {\sum }_{k = 1}^{n} {W}_{k} \times ( a current {LD}_{k} - a previous {LD}_{k} ) ,$$
wherein the Wk is a weighting factor of a k-th load.
